(19) United States
(12) Patent Application Publication
(10) Pub. No.: US 2024/0124283 A1
(43) Pub. Date: Apr. 18, 2024

(54) HEIGHT-ADJUSTABLE SLAG TRANSPORTER

(71) Applicant: TML Technik GmbH, Monheim am Rhein (DE)

(72) Inventors: Christof MIKAT, Monheim am Rhein (DE); Johannes REIF, Duesseldorf (DE)

(21) Appl. No.: 18/396,262

(22) Filed: Dec. 26, 2023

Related U.S. Application Data
(63) Continuation of application No. 17/547,904, filed on Dec. 10, 2021.

(30) Foreign Application Priority Data
Dec. 10, 2020 (DE) 102020007557.6

(51) Int. Cl. B66F 9/065; B62D 55/08; B66F 9/075

(52) U.S. Cl. CPC B66F 9/065; B62D 55/08; B66F 9/07577; B66F 9/07581; C21B 7/00; C21B 2400/05

(57) ABSTRACT

A self-propelled slag transporter, The self-propelled slag transporter includes a drive, a chassis, a lifting device with at least one lifting drive and a receiving device for receiving a metallurgical transport container, in particular a slag container, wherein the receiving device is designed to be height-adjustable by the lifting device, and wherein the chassis has at least two crawler tracks.

### FIELD OF THE INVENTION

The invention relates to a self-propelled slag transporter for metallurgical transport containers, in particular slag containers, wherein the slag transporter is adapted to be positioned under the transport container, to lift it, to transport it and to set it down again. The invention is further directed to a transport system comprising a self-propelled slag transporter and a metallurgical transport container.

### TECHNOLOGICAL BACKGROUND OF THE INVENTION

During the production of steel, large quantities of liquid slag are produced, which are transported and subsequently processed. For this purpose, the slag is filled into a metallurgical transport container, also known as a slag container or slag bucket, which can hold up to 100 mt of slag. After filling, the transport container is transported in the steel mill so that the slag can then be further processed. Here, the extremely high temperature of the slag to be transported of more than 1000° C. and the high weight pose difficulties. Furthermore, the space in a steel mill is usually very cramped and the floor very uneven, so that the transport of liquid slag is a challenge.

Slag transporters are known in the prior art. DE 100 08 637 A1 teaches a slag transporter which can pick up, transport and dump a container of hot slag. A tipping device attached to the transporter is used for this purpose. The document DE 229 15 547 U1 discloses a slag transporter with wheels that can pick up transport containers with liquid slag. For this purpose, this slag transporter has tilting arms with supporting pins. In order to be able to pick up the slag container from an elevated location, this slag transporter further comprises at least one height-adjustable axle device which brings the slag transporter into an inclined position. The tilting arms swing back after the slag container has been picked up, so that the container can be placed on the transporter and transported. Each of the documents DE 20 02 080 A and DE 17 55 833 A disclose a slag transporter with wheels and a frame consisting of two parallel frame sides which are firmly connected to each other at one end only by a transverse frame part which supports a drivers cab. The frame is adjustable in height and is used to hold slag containers that can be transported and parked. These designs are disadvantageous because the containers to be accommodated must have a certain width to be compatible with the frame of the slag transporter. US 2008/0253872 A1 describes a trailer with wheels having a similar U-shape. The lifting device is used to pick up and place the containers, which are placed on the ground. Finally, CN 210236898 U describes a slag transporter that runs on rails and can pick up and transport slag located underneath it by means of a chain and a shovel.

However, these known slag transporters are poorly maneuverable due to their design. Thus, many time-consuming and cumbersome maneuvers are common when driving such slag transporters to transport the slag in these facilities. Furthermore, many transporters are not capable of carrying heavy loads, especially in the rough terrain of a steel mill. These slow down operations and reduce the efficiency of a steel mill.

Therefore, there is a need in the art for a self-propelled slag transporter, which are easy to handle, for metallurgical transport containers that ensures that such transport containers with liquid slag can be transported safely and quickly in confined spaces.

### BRIEF DESCRIPTION OF THE INVENTION

The invention provides a self-propelled slag transporter for metallurgical transport containers according to claim 1, which is easy to handle and enables such transport containers with liquid slag to be transported safely and quickly in confined spaces. The invention provides the transport system of claim 7. Further advantageous embodiments are given in the sub-claims.

Therefore, in one aspect, the invention is directed to a self-propelled slag transporter comprising a drive, a chassis, a lifting device with at least one lifting drive and a receiving device for receiving a metallurgical transport container, in particular a slag container, wherein the receiving device is designed to be height-adjustable by the lifting device characterized in that the chassis has at least two crawler tracks.

In a further aspect, the invention relates to a transport system comprising a self-propelled slag transporter as claimed herein and a metallurgical transport container, in particular a slag container, wherein the slag transporter is deswigned such that it can be positioned under the metallurgical transport container on four sides, preferably on two sides, and can lift and transport the same.

The slag transporter according to the invention has excellent characteristics. In particular, compared with established slag transporters, the slag transporter exhibits great maneuverability and can transport liquid slag safely and quickly in confined spaces such as in a steel mill.

### DESCRIPTION

The slag transporter described herein is self-propelled and includes a drive and a chassis. The drive and the chassis cooperate to allow the slag transporter to move. The drive can be any drive known and suitable for this purpose, for example, a diesel engine, electric motor, optionally with an accumulator, or a hydrogen drive. The chassis has at least two crawler tracks. As a result, the slag transporter has comparatively large contact surfaces and thus comparatively large traction. This is advantageous in a rough terrain, such as in a steel mill, for transporting heavy loads. Furthermore, the at least two crawler tracks can travel in opposite directions, allowing the slag transporter to turn on the spot, making it more maneuverable and easier to handle.

The slag transporter also has a lifting device with at least one lifting drive. The lifting device can be operated hydraulically, mechanically or electrically.

The slag transporter comprises a receiving device for receiving a metallurgical transport container, wherein the receiving device is height-adjustable by the lifting device. Preferably, the receiving device has a substantially flat receiving surface. “A substantially planar receiving surface”, as used herein, means that it may be plate-shaped. The receiving device may include recesses. The receiving device may have a removable portion so that maintenance of the slag transporter is simplified.

The metallurgical transport container can preferably be designed to receive slags, metallurgical products and slag raw materials, both in cold and in hot or liquid form. The transport container may be any container suitable for this purpose, such as a slag container or a known slag bucket. For the purposes of the invention, “slag” is understood to mean slag according to DIN 4301. This includes, for example, ironworks slag such as blast furnace slag, steel mill slag such as converter slag, electric furnace slag, stainless steel slag, secondary metallurgical slag and metal mill slag.

The slag transporter is preferably designed to function in hot environments such as a steel mill and to withstand the high temperatures and mechanical and chemical stresses on a sustained basis.

In particular, the slag transporter is dimensioned in terms of height and width such that it can be positioned below a transport container and the height of the pickup device can be changed by means of the lifting device in such a way that the metallurgical transport container can be lifted so that it is no longer in contact with the footprint, transported and set down again. The base area of the slag transporter is larger than that of the metallurgical transport container. Due to its relatively small dimensions, the slag transporter is handy in the confined conditions of a steel mill. When transporting the metallurgical transport containers, the slag transporter according to the invention requires fewer maneuvers than known slag transporters.

Particularly preferred, the slag transporter is dimensioned in terms of height and width in such a way that it can be positioned below a metallurgical transport container and the height of the receiving device can be changed by means of the lifting device in such a way that the metallurgical transport container can be lifted so that it is no longer in contact with the footprint, transported and set down again. In this case, the base area is identical to the base surface of the metallurgical transport container. This makes the slag transporter particularly easy to handle.

Even more particularly preferred, the slag transporter is dimensioned in terms of height and width such that it can be positioned below a metallurgical transport container and the height of the receiving device can be changed by means of the lifting device in such a way that the metallurgical transport container can be lifted so that it is no longer in contact with the base surface, transported and set down again. In this case, the base area of the slag transporter is smaller than the base area of the metallurgical transport container. If the slag transporter is positioned below the metallurgical transport container, it does not increase its base area. Thus, this embodiment of the slag transporter is the easiest to handle.

“Base area of the slag transporter”, as used herein, refers to the area below the slag transporter on level ground as viewed from the top view.

“Base area of the metallurgical transport container”, as used herein, refers to the area below said container on level ground as viewed from the top view.

In a preferred embodiment of the invention, for height adjustment of the receiving device, the at least one, preferably each lifting drive of the lifting device is connected to the receiving device. The receiving device can be height-adjustable in a purely rotational manner, is preferably height-adjustable in a purely translational manner.

Preferably, the lifting device has four lifting drives. Thus, a uniform lifting of the transport container can be achieved.

In a preferred embodiment of the invention, the slag transporter is designed to pick up and transport a load of up to 100 mt, preferably up to 80 mt. This allows a sufficient amount of slag to be transported.

In a still further preferred embodiment of the invention, the receiving device is designed to be adjustable in height by the lifting device by 1 cm to 60 cm, preferably 10 cm to 45 cm and even more preferably 20 cm to 30 cm.

In a further aspect, the invention relates to a transport system comprising a self-propelled slag transporter as described herein and a metallurgical transport container, in particular a slag container, wherein the slag transporter is designed such that it can be positioned below the metallurgical transport container from four sides, preferably from two sides and that the slag transporter can lift and transport the metallurgical transport container. “Four sides”, as used herein, means that the slag transporter can be positioned under the metallurgical transport container from the right side, from the left side, from the front and from the rear. “Two sides”, as used herein, means that the slag transporter can be positioned under the metallurgical transport container from only two of the four sides just mentioned, but preferably from the front and from the rear. This can be achieved, for example, by the metallurgical transport container having means, such as walls or support legs, spacing the transport container from the ground.

Preferably, the transport system comprises a remote control adapted to be carried by an operator located adjacent the slag transporter, the remote control being connectable to at least one electronic unit in the slag transporter via a radio link or by means of a cable. The radio connection can be established as WLan, Bluetooth or according to another transmission standard. This makes handling safer.

Preferably, the metallurgical transport container has means on the underside so that the metallurgical transport container is spaced from the floor in such a way that the slag transporter can be positioned under the metallurgical transport container on four sides, preferably on the two sides, in order to lift it by adjusting the height of the receiving device. These means can be walls or support legs. Preferably, the means are support legs.

In another preferred embodiment, the slag transporter of the transport system comprises at least a first positioning unit adapted to position the slag transporter in transport position below the metallurgical transport container so that it can be lifted and transported. The positioning unit can be electronic or positively. This facilitates positioning of the slag transporter to transport the transport container.

These and other aspects, features and advantages of the invention will be apparent to those skilled in the art from a study of the following detailed description and claims. In this regard, any feature from any aspect of the invention may be employed in any other aspect of the invention. Further, it is understood that the examples contained herein are intended to describe and illustrate the invention but are not intended to limit the invention and, in particular, the invention is not limited to these examples. Numerical ranges given in the format “from x to y” include said values as well as those values which are within the range of the respective measurement accuracy known to those skilled in the art. When multiple preferred numerical ranges are specified in this format, it is understood that all ranges resulting from the combination of the various endpoints are also included.

For better illustration, an example of an embodiment is described below with reference to the figures.

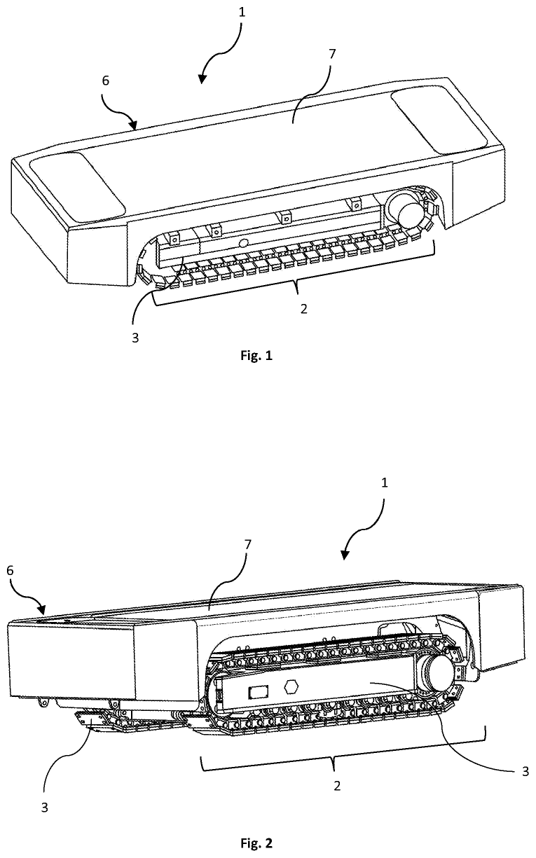

FIG. 1 a schematic perspective view of the slag transporter 1, wherein the lifting device 4 is set to the lowest height;

FIG. 2 a schematic perspective view of the slag transporter 1, with the lifting device 4 set to the highest height;

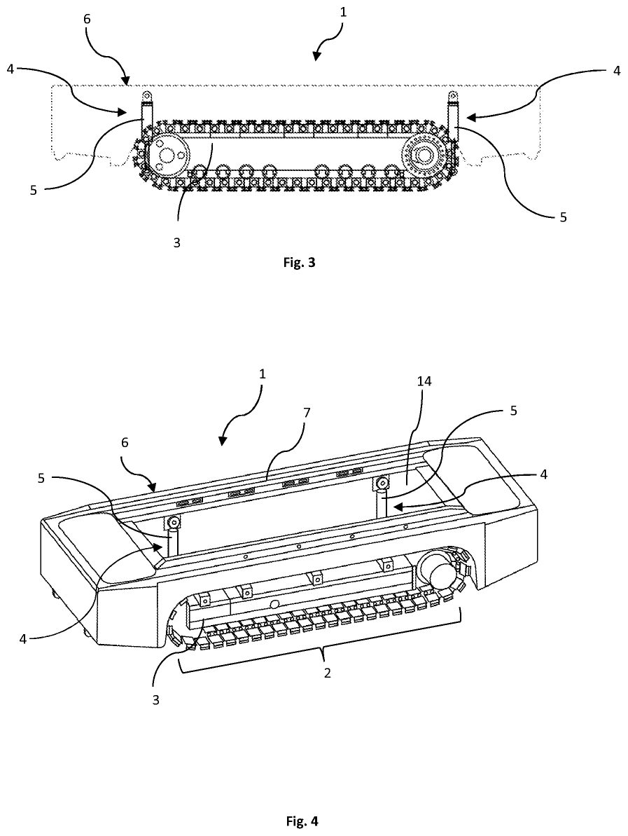

FIG. 3 a schematic perspective view of the slag transporter 1 with two lifting drives 5 and two lifting devices 4;

FIG. 4 a schematic perspective view of the slag transporter 1, wherein the receiving device 6 has a recess 14, two lifting devices 4 and two lifting drives 5.

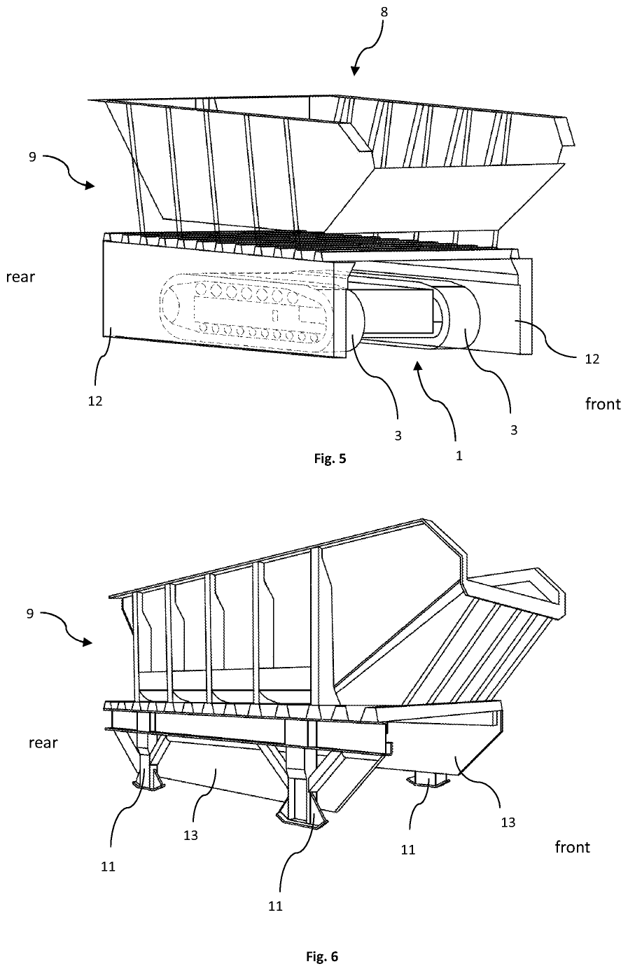

FIG. 5 a schematic perspective view of the transport system 8, wherein the slag transporter 1 is positioned below the metallurgical transport container 9 and the metallurgical transport container 9 is spaced from the floor by two walls 12;

FIG. 6 a metallurgical transport container 9 spaced from the ground by support legs 11.

FIG. 1 shows a slag transporter 1 with a drive, a chassis 2 with two crawler tracks, whereby only one crawler track 3 can be seen. The crawler track 3 and the concealed crawler track are arranged parallel to each other. Furthermore, the slag transporter 1 has a receiving device 6 which has a substantially flat receiving surface 7. In this case, the receiving device 6 is set to the lowest height so that the slag transporter 1 can be positioned below the metallurgical transport container without coming into contact with the metallurgical transport container. The drive as well as the lifting device with at least one lifting drive are arranged in the slag transporter 1 and are not shown in the FIG. 1. The slag transporter 1 is designed to pick up and transport a load of up to 100 mt.

FIG. 2 shows the slag transporter 1 of FIG. 2 with the receiving device 6 having reached the maximum height. In this position, the slag transporter 1 has lifted the metallurgical transport container and can transport it. The height of the receiving device 6 can be adjusted from 1 cm to 60 cm.

FIG. 3 schematically shows the slag transporter 1 together with two internal lifting drives 5 and lifting devices 4, parts of the lifting devices 4 being covered by the crawler track 3. Another two lifting drives and lifting devices are located on the opposite side and are covered by the illustrated lifting drives 5 and lifting devices 4. A crawler track 3 is shown obscuring the drive on the opposite side. The crawler tracks are aligned parallel to each other. The receiving device 6 is set to the lowest height and can be adjusted in height purely by translation.

FIG. 4 shows the slag transporter 1 with a drive, a chassis 2 with two crawler tracks 3, whereby only one crawler track is visible. The crawler track 3 and the concealed track are arranged parallel to each other. The receiving device 6 has a recess 14. The lifting drive 5 and the lifting device 4 are partially concealed by the receiving device 6. The pickup device 6 is set to the lowest height.

FIG. 5 shows the transport system 8 with the slag transporter 1 with two crawler tracks 3 positioned below the metallurgical transport container 9. The receiving device and the receiving surfaces are not shown for the sake of clarity. The metallurgical transport container 9 stands on two walls 12 and is thus spaced from the floor. Thus, the slag transporter 1 can be positioned under the metallurgical transport container 9 from the front and rear on both sides. The slag transporter 1 can be positioned from the front under the transport container 9, lift the transport container 9, transport it, park it and pass under the container. This is advantageous compared to slag transporters known in art, as it allows the metallurgical transport container to be parked in a more space-saving manner, for example, in a row. The slag transporter 1 is concealed by the front wall of the two walls 12 and is therefore shown partially dashed. The metallurgical transport container 9 has an angular shape and is open at the top. The metallurgical transport vessel 9 is designed to receive both cold and hot or liquid slag.

FIG. 6 shows a metallurgical transport unit 9 spaced from the floor by support legs 11. Apertures 13 are attached to the side. The slag transporter 1 can be positioned on both sides from the front and rear under the metallurgical transport container 9. The metallurgical transport container 9 has an angular shape and is open at the top. The metallurgical transport container 9 is designed to hold both cold and hot or liquid slag.

1-10. (canceled)

11. A self-propelled slag transporter comprising a drive, a chassis, a lifting device with at least one lifting drive and a receiving device for receiving a metallurgical transport container, in particular a slag container, wherein the receiving device is designed to be height-adjustable by the lifting device, and wherein the chassis has at least two crawler tracks, and wherein for height adjustment of the receiving device the at least one lifting drive of the lifting device is connected to the receiving device and the chassis, such that the height of the receiving device is height-adjustable in a purely translational manner.

12. The self-propelled slag transporter according to claim 11, wherein the lifting device has four lifting drives, and/or;
the base area of the slag transporter is at most as large as the base area of the metallurgical transport container.

13. The self-propelled slag transporter according to claim 11, wherein the receiving device has an essentially flat receiving surface.

14. The self-propelled slag transporter according to claim 11, wherein the slag transporter is designed to take-up and transport a load of up to 100 mt.

15. The self-propelled slag transporter according to claim 11, wherein the receiving device is designed to be height-adjustable by the lifting device by 1 cm to 60 cm and/or
the height and width of the slag transporter is dimensioned such that it can be positioned below the metallurgical transport container and the height of the receiving device can be changed by means of the lifting device in such a way that the metallurgical transport container can be lifted, such that when the metallurgical transport container is no longer in contact with a standing surface, it can be transported and put down again, and the slag transporter can be moved out on a front side and a rear side.

16. The self-propelled slag transporter according to claim 11, wherein the receiving device is designed to be height-adjustable by the lifting device by 10 cm to 45 cm and/or
the height and width of the slag transporter is dimensioned such that it can be positioned below the metallurgical transport container and the height of the receiving device can be changed by means of the lifting device in such a way that the metallurgical transport container can be lifted, such that when the metallurgical transport container is no longer in contact with a standing surface, it can be transported and put down again, and the slag transporter can be moved out on a front side and a rear side.

17. The self-propelled slag transporter according to claim 11, wherein the receiving device is designed to be height-adjustable by the lifting device by 20 cm to 30 cm and/or
the height and width of the slag transporter is dimensioned such that it can be positioned below the metallurgical transport container and the height of the receiving device can be changed by means of the lifting device in such a way that the metallurgical transport container can be lifted, such that when the metallurgical transport container is no longer in contact with a standing surface, it can be transported and put down again, and the slag transporter can be moved out on a front side and a rear side.

18. The self-propelled slag transporter according to claim 11, further comprising a metallurgical transport container, in particular a slag container, wherein the slag transporter is designed such that it can be positioned below the metallurgical transport container from four sides, and that the slag transporter can lift and transport the metallurgical transport container.

19. The self-propelled slag transporter according to claim 11, further comprising a metallurgical transport container, in particular a slag container, wherein the slag transporter is designed such that it can be positioned below the metallurgical transport container from two sides and that the slag transporter can lift and transport the metallurgical transport container.

20. The self-propelled slag transporter according to claim 11, further comprising a transport system comprising a remote control which is suitable to be carried by an operator who is located next to the slag transporter, the remote control being connected to the slag transporter via a radio link or by means of a cable with at least one electronic unit in the slag transporter.

21. The self-propelled slag transporter according to claim 20, wherein the metallurgical transport container has support legs on the underside, such that the metallurgical transport container is spaced from the ground in such a way that the slag transporter can be positioned below the metallurgical transport container from four sides in order to lift the metallurgical transport container by adjusting the height of the receiving device.

22. The self-propelled slag transporter according to claim 20, wherein the metallurgical transport container has support legs on the underside, such that the metallurgical transport container is spaced from the ground in such a way that the slag transporter can be positioned below the metallurgical transport container from two sides in order to lift the metallurgical transport container by adjusting the height of the receiving device.

23. The self-propelled slag transporter according to claim 20, wherein the slag transporter has at least one first positioning unit which is designed to position the slag transporter in the transport position under the metallurgical transport container, such that it can be lifted and transported.
